(19) United States
(12) Patent Application Publication
(10) Pub. No.: US 2026/0310503 A1
(43) Pub. Date: Oct. 8, 2026

(54) Phase-Aware Resource Tuning Using Behavioral Inference

(71) Applicant: Arm Limited, Cambridge (GB)

(72) Inventors: Michael BARTLING, Austin, TX (US); Brendan James MORAN, Coton (GB); Dam Sunwoo, Austin, TX (US); Andreas Lars SANDBERG, Cambridge (GB)

(21) Appl. No.: 19/459,868

(22) Filed: Jan. 26, 2026

Related U.S. Application Data
(60) Provisional application No. 63/783,486, filed on Apr. 4, 2025.

(51) Int. Cl. G06F 9/50; G06F 1/3296; G06F 9/38

(52) U.S. Cl. CPC G06F 9/5011; G06F 1/3296; G06F 9/3802; G06F 9/3842

(57) ABSTRACT

Technologies are disclosed for tuning resources of a processing unit based on behavioral phase-of-execution determinations. A phase-of-execution of code executing on a processing unit is inferred from processor-level execution events detectable at an architectural level. A tuning controller applies phase-specific adjustments to one or more hardware resources in real time with execution of the code. In some embodiments, tuning prepares for a predicted subsequent phase-of-execution and is applied prior to commencement of the predicted phase. Expected performance benefit may be evaluated by estimating the probability that a predicted phase is correct, the performance improvement if correct, and potential degradation if incorrect, with tuning applied only when an overall expected benefit is positive. Phase-specific adjustments may include modifying power gating, voltage or frequency levels, cache configuration, prefetching behavior, branch prediction parameters, or speculative-execution mechanisms. These techniques enable adaptive, phase-aware optimization of processing-unit resources without reliance on static knowledge of code structure.

### CROSS-REFERENCE TO RELATED APPLICATIONS

This application claims the benefit of U.S. Provisional Application No. 63/783,486, filed Apr. 4, 2025, the entire contents of which are incorporated herein by reference.

### BACKGROUND

Modern processing units incorporate a range of configurable hardware resources, such as voltage and frequency controls, cache hierarchies, prefetch mechanisms, branch predictors, and speculative-execution settings, that influence performance and power characteristics during program execution. These resources are often configured using generalized policies, static defaults, or coarse system-level heuristics. Because workload behavior can vary significantly across different portions of execution, a configuration that is suitable for one interval may be less effective in another, particularly when the underlying architectural activity changes in ways not observable at the software-logic level.

It should be noted that behavioral characteristics of processor-level events may indicate shifts in memory intensity, computational demand, control-flow regularity, or other execution dynamics. However, even though these behavioral shifts occur during runtime, conventional resource-management approaches typically do not incorporate fine-grained behavioral characterizations or predictive insight into how execution patterns will change. Conventional approaches have not attempted, or succeeded in, aligning resource settings more closely to observed or anticipated execution behavior using information derived dynamically while code is executing.

### BRIEF SUMMARY

Phase-aware resource turning using behavior inference is described. In some embodiments, processor-level execution events are analyzed to infer a phase-of-execution of code running on a processing unit, and this behavioral determination is used to guide real-time tuning of hardware resources. Phase-specific adjustments may be applied to parameters such as power gating, dynamic voltage and frequency settings, cache configuration, prefetch behavior, branch prediction, or speculative-execution controls. In certain implementations, the tuning may be performed in anticipation of a predicted subsequent phase-of-execution, optionally using probability estimates or performance-impact evaluations to determine whether a proposed adjustment is expected to yield a net benefit.

In some aspects, a method of tuning a processing unit executing code, includes: receiving a determination of a phase-of-execution of code being executed by a processing unit, the phase-of-execution having been inferred from processor-level execution events detectable at an architectural level of the processing unit during execution of code; and tuning at least one resource of the processing unit according to a phase-specific adjustment responsive to the phase-of-execution determination, the tuning being performed in real time with execution of the code. For example, the tuning can be an optimization (e.g., the phase-specific adjustment) can be for a predicted phase-of-execution believed to follow a currently inferred phase. Appreciably, inference accuracy is of a predicted phase-of-execution is significant, as an inaccurate prediction and corresponding adjustment can degrade performance.

In some aspects, a tuning system is configured to interface with a processing unit executing code, where the tuning system includes: a monitoring interface configured to receive, from the processing unit, processor-level execution events detectable at an architectural level during execution of the code; a phase-inference engine configured to infer a phase-of-execution of the code based on the processor-level execution events; and a tuning controller configured to tune at least one resource parameter of the processing unit according to a phase-specific adjustment responsive to the inferred phase-of-execution, wherein the tuning controller performs the tuning in time with execution of the code.

In some aspects, a non-transitory computer-readable medium stores instructions which, when executed by one or more processors of a processing unit, cause the processing unit to: receive a determination of a phase-of-execution of code being executed by the processing unit, the phase-of-execution having been inferred from processor-level execution events detectable at an architectural level of the processing unit during execution of the code; and tune at least one resource parameter of the processing unit according to a phase-specific adjustment responsive to the determined phase-of-execution, the tuning being performed in real time with execution of the code.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A illustrates an architecture for tuning processing unit resources based on behavioral phase-of-execution inference.

FIG. 1B illustrates an example organization of the tuning controller and its interaction with tunable resource categories.

FIG. 1C illustrates a representational schematic of a behavioral sensor for generating output including behavioral indicators.

FIG. 2A illustrates a specific implementation of a system with a behavioral sensor used to determine phase-of-execution from processing unit events.

FIG. 2B illustrates a specific implementation of the preprocessing circuitry present in some embodiments of the system of FIG. 2A.

FIG. 2C shows a schematic diagram where a machine-learning (ML) profiler establishes behavioral signatures for the profile storage medium.

FIG. 3 illustrates a method for phase-aware resource tuning in a processing unit.

FIG. 4 provides a sample use case for predicting phase-of-execution and for responsively tuning a processing unit to improve performance.

### DETAILED DESCRIPTION

Phase-aware resource tuning using behavioral inference is now described. In general, processor-level execution events detectable at an architectural or microarchitectural level are monitored while code executes on a processing unit. These events are converted into behavioral indicators that characterize how the workload is currently exercising underlying hardware resources. A phase-inference mechanism correlates the indicators with stored phase information to determine a behavioral phase-of-execution, optionally together with a prediction of a subsequent phase and associated confidence values.

A phase-of-execution, as used herein, represents a workload pattern state that persists over a region of execution and is distinguishable by characteristic patterns of processor-level activity. Different phases may exhibit different memory intensity, computational balance, or control-flow regularity, leading them to interact with power controls, cache hierarchies, prefetch logic, branch predictors, speculative-execution mechanisms, and other hardware resources in different ways. By basing phase determinations on dynamic behavioral measurements rather than on static code structure, the same inference techniques can be applied across a variety of workloads and processor implementations.

In some embodiments, behavioral indicators are obtained through a monitoring interface that receives processor-level execution events and forwards derived indicators to a phase-inference engine. A tuning controller consumes the resulting phase-of-execution information and selects phase-specific adjustments for one or more tunable resources of the processing unit. The controller may further consider prediction confidence, expected performance impact, and potential overhead so that not every phase determination results in a configuration change. The following figures illustrate example architectures and methods for implementing these monitoring, inference, and tuning functions.

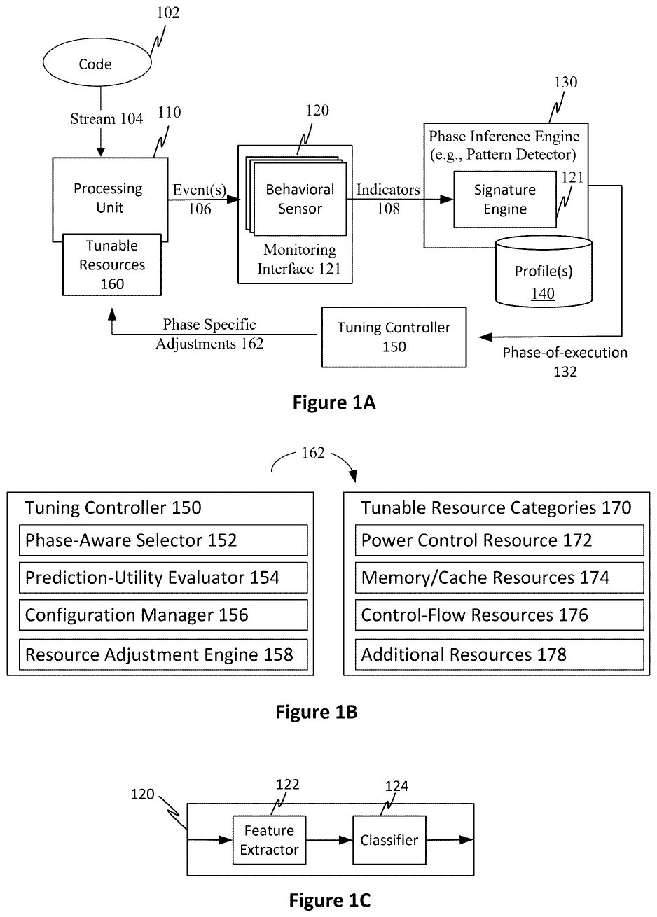

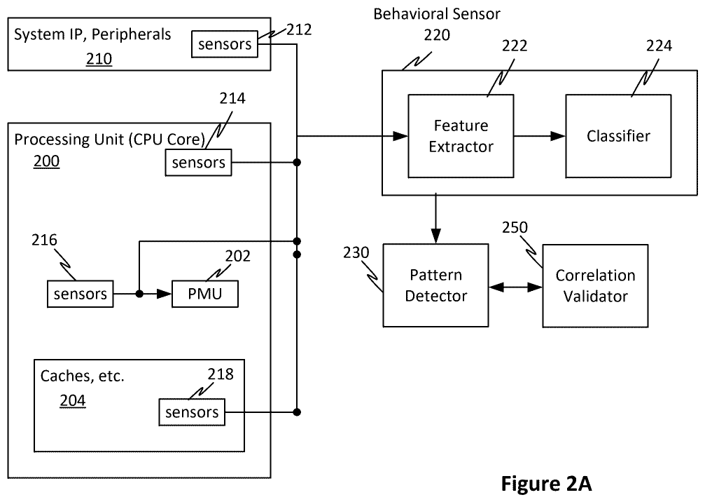

FIG. 1A illustrates an architecture for tuning processing unit resources based on behavioral phase-of-execution inference. Code 102 is streamed 104 to and is executed by a processing unit 110, which results in occurrences of processor-level execution events 106. A monitoring interface 121 comprising of a set of behavioral sensors 120 observes these events and derives behavior indicators 108 that capture salient aspects of execution behavior at the architectural level. The indicators 108 are provided to a phase inference engine 130, which includes a signature engine 131 configured to construct one or more observed behavior signatures and to pattern-match them against stored profiles 140. These profiles 140 represent a catalog of known phases-of-execution, allowing the phase inference engine 130 to output an inferred phase-of-execution 132 for the running code stream. In some embodiments, the inference engine 130 operates in near real time, such that the inferred phase can be acted upon before a subsequent phase transition occurs. Generally, the phase inference engine 130, which can be referred to as a pattern detector, produces an inferred phase-of-execution 132 in a manner that enables tuning or optimization actions that improve processing unit 110 performance without incurring overhead that would negate the benefit. The system of FIG. 1A can operate in a platform-independent manner performed without assumptions about or reliance on the codebase structure.

Tuning controller 150 receives the inferred phase-of-execution 132 from the phase inference engine 130 and, in some embodiments, further predicts an upcoming phase-of-execution based on observed trends or phase transitions. In some embodiment, the phase-of-execution 132 received at the tuning controller 150 can be a prediction of an upcoming phase. Timing information significant to when adjustments 162 are to be applied can also be conveyed to the tuning controller 150. The tuning controller 150 determines a set of phase-specific adjustments 162 to be applied to one or more tunable resources 160 of the processing unit 110. Such adjustments may include, for example, modifying parameters related to voltage, frequency, memory bandwidth, or cache allocation. In certain embodiments, the tuning controller 150 dynamically applies or schedules these resource adjustments to optimize processing unit operation for the predicted or current phase-of-execution. The tuning controller 150 may also account for prediction confidence, anticipated performance gain, or constraint policies to selectively trigger reconfiguration, thereby maintaining system stability and minimizing unnecessary resource changes.

FIG. 1B illustrates an example organization of the tuning controller 150 and its interaction with tunable resource categories 170, into which the tunable resources 160 can be classified. In some embodiments, the tuning controller 150 may include a phase-aware selector 152 configured to choose phase-specific tuning strategies based on the inferred phase-of-execution. A prediction-utility evaluator 154 may assess whether anticipated gains or efficiencies warrant a transition of resource states. A configuration manager 156 may determine sets of adjustment parameters suited for the current or predicted phase, and a resource adjustment engine 158 may implement the selected parameter changes (e.g., phase specific adjustments 162) in the processing unit 110 or the resource-associated architectural component. The tuning controller 150 may interact with several categories of tunable resources 160, including a power control resource 172, memory and cache resources 174, control-flow resources 176, and additional resources 178. This arrangement enables phase-aware, fine-grained, and adaptive management of hardware resources in accordance with system policies and workload characteristics.

In some embodiments, the phase-aware selector 152 of tuning controller 150 is configured to select from a plurality of pre-established tuning strategies, each corresponding to a distinct phase-of-execution as determined by the phase inference engine 130. The strategies may specify particular combinations or sequences of resource adjustments that are empirically matched to optimize behavior for detected phases such as memory-bound, compute-bound, or I/O-intensive operation. The prediction-utility evaluator 154 may evaluate the likely benefit of transitioning to a new configuration by considering historical phase patterns, confidence metrics, and potential performance trade-offs associated with changes to resource settings. This evaluator 154 may selectively block or enable resource transitions based on a threshold confidence or on projected net utility. The configuration manager 156 is responsible for translating phase-based strategies into concrete parameter sets, mapping abstract tuning directives into specific voltage, frequency, cache allocation, or memory access settings for deployment. The resource adjustment engine 158 interfaces directly with the processing unit 110 and other architectural components, issuing signals or control sequences to modify operational parameters in real time, with support for staged, synchronized, or rollback-capable changes as needed for system integrity.

Multiple categories of tunable resources may be addressed by the tuning controller 150 The power control resource 172 may correspond to voltage regulators, dynamic frequency scaling interfaces, or clock gating mechanisms that adaptively change energy usage characteristics. Memory and cache resources 174 may include, but are not limited to, last-level cache (LLC) ways, memory interleaving patterns, row buffer management policies, or programmable memory controllers that affect memory hierarchy behavior and data locality. Control-flow resources 176 may encompass branch predictor configuration, prefetcher aggressiveness, out-of-order scheduling windows, speculative execution settings, or any feature that modifies instruction flow and prediction. Additional resources 178 may account for proprietary accelerators, reconfigurable logic, security domains, thermal management features, or any hardware subsystem providing tunable operational parameters. The resource categories 170 are intended to be illustrative and not comprehensive. Application of phase-specific settings to any such category may be combined, staged, or prioritized by the configuration manager 156 according to system policy or phase-transition timing.

### Illustrative Elaborations

Although operations of the tuning controller 150 can vary from implantation to implementation, some illustrative considerations, components, and settings are provided below, which are provided as contextual non-limiting examples. One of ordinary skill will recognize that alternative implementations to those delineated below, which alternatives are to be considered within scope of this disclosure.

In some cases, the real-time tuning functionality may be achieved through a carefully orchestrated timing mechanism that operates concurrently with code execution without disrupting the execution flow. The tuning controller 150 may implement a multi-stage timing architecture that separates phase detection latency from configuration application latency to maintain execution continuity. In some embodiments, the phase inference engine 130 may operate with a low target detection latency (e.g., less than 10,000 processor cycles in some instances) to ensure that phase determinations can be acted upon before subsequent phase transitions occur. The behavioral sensor 120 may buffer incoming execution events 106 in a circular buffer structure that maintains a sliding window of recent processor activity, allowing the phase inference engine 130 to continuously analyze behavioral patterns without blocking the execution stream.

In some instances, the synchronization between phase detection and resource adjustment may be managed through a dual-clock domain architecture where the monitoring interface 121 operates synchronously with the processing unit 110 while the tuning controller 150 operates in a separate timing domain. This arrangement may allow the tuning controller 150 to prepare configuration changes during phase detection without interfering with the primary execution pipeline. The resource adjustment engine 158 may implement a staged application mechanism that applies configuration changes during natural execution boundaries such as cache line fills, branch resolution cycles, or instruction retirement windows to minimize performance disruption.

In some embodiments, the tuning controller 150 may maintain a configuration pipeline that pre-computes multiple potential resource adjustments based on probable phase transitions. The prediction-utility evaluator 154 may continuously assess the likelihood of various phase transitions and pre-stage corresponding configuration parameters in preparation registers. When a phase transition is confirmed by the phase inference engine 130, the resource adjustment engine 158 may apply the pre-staged configuration through atomic register updates that complete within a single processor cycle. This predictive staging approach may reduce the effective configuration latency from hundreds of cycles to single-digit cycles.

In some cases, the timing mechanism may further incorporate a confidence-based throttling system that adjusts the aggressiveness of configuration changes based on phase detection certainty. When the phase inference engine 130 reports high confidence values above a predetermined threshold, the tuning controller 150 may apply configuration changes immediately upon phase detection. For moderate confidence values, the controller may implement a delayed application strategy that waits for additional behavioral confirmation before committing to resource adjustments. Low confidence detections may trigger a conservative mode where only minimal, reversible configuration changes are applied to avoid performance degradation from incorrect phase determinations.

The synchronization methodology may employ a distributed coordination protocol where individual tunable resource categories 170 maintain their own configuration state machines. Each resource category may implement a local synchronization mechanism that coordinates with the central resource adjustment engine 158 through a message-passing interface. The power control resource 172 may implement voltage and frequency transitions using hardware-assisted scaling that completes within microsecond timeframes. Memory and cache resources 174 may utilize cache coherency protocols to ensure that cache allocation changes do not corrupt ongoing memory operations. Control-flow resources 176 may coordinate branch predictor reconfigurations with pipeline flush boundaries to maintain prediction accuracy during transitions.

In certain embodiments, the real-time tuning system may implement a rollback mechanism that monitors performance metrics during configuration transitions and automatically reverts changes if performance degradation is detected. The configuration manager 156 may maintain shadow copies of previous resource configurations and implement a watchdog timer that triggers automatic rollback if expected performance improvements are not observed within a specified time window. This safety mechanism may ensure that incorrect phase detections or suboptimal configuration choices do not permanently degrade system performance.

In some embodiments, the latency requirements for different tuning operations may vary based on the criticality and reversibility of each resource adjustment. Power gating operations may require longer lead times due to the physical constraints of voltage regulation, while cache allocation changes may be applied more rapidly through memory management unit updates. The tuning controller 150 may implement a priority-based scheduling system that sequences configuration changes according to their latency requirements and performance impact potential. High-impact, low-latency changes such as prefetcher weight adjustments may be applied immediately, while lower-priority changes such as speculative execution window sizing may be deferred to avoid timing conflicts.

In some cases, a concurrent execution model may be supported through a non-blocking communication architecture between the phase inference engine 130 and the tuning controller 150. The phase inference engine 130 may output phase determinations to a lock-free queue structure that allows the tuning controller 150 to consume phase information without blocking the inference process. Similarly, the tuning controller 150 may communicate with individual tunable resources 160 through dedicated control channels that operate independently of the main execution datapath. This separation may ensure that tuning operations do not introduce stalls or bubbles into the processor pipeline.

In some embodiments, the timing mechanism may incorporate adaptive latency management that adjusts detection and application timeframes based on observed workload characteristics. For workloads with frequent phase transitions, the system may reduce detection latency thresholds to enable more responsive tuning at the cost of increased power consumption. For workloads with stable, long-duration phases, the system may increase detection latency to improve accuracy while reducing unnecessary configuration overhead. The prediction-utility evaluator 154 may continuously monitor phase transition frequencies and adjust timing parameters accordingly to optimize the trade-off between responsiveness and stability.

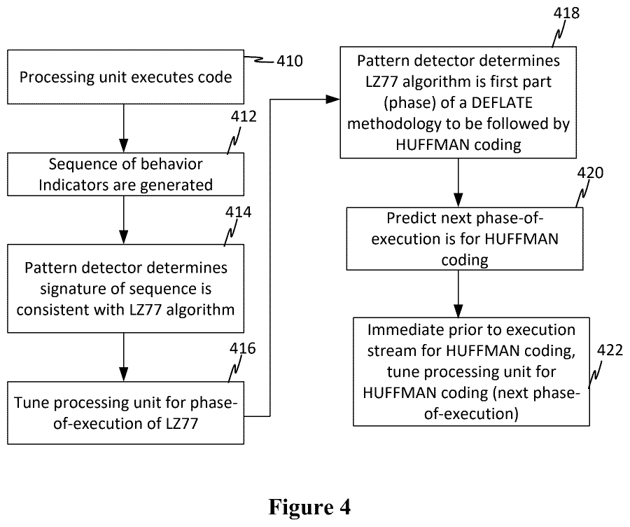

The real-time tuning functionality may further implement a hierarchical timing structure where coarse-grained phase detection operates at millisecond timescales while fine-grained behavioral adjustments operate at microsecond timescales. The phase inference engine 130 may detect major algorithmic phases such as the transition from LZ77 compression to HUFFMAN coding (see FIG. 4) over longer time windows, while simultaneously tracking micro-phases such as loop iterations or function calls over shorter windows. This multi-resolution approach may enable both strategic resource allocation for major phase transitions and tactical optimizations for transient behavioral patterns. The synchronization mechanism may employ a dual-buffer architecture within one or more of the behavioral sensors 120 to maintain continuous event monitoring while phase inference operations are performed. The first buffer may capture incoming execution events 106 while the second buffer provides stable data to the phase inference engine 130 for analysis. Buffer switching may occur at predetermined intervals or when buffer capacity thresholds are reached, ensuring that no execution events are lost during phase detection processing. The phase inference engine 130 may implement a pipelined architecture where signature matching operations are distributed across multiple processing stages, allowing new behavioral indicators 108 to be analyzed while previous indicators are still being processed in earlier pipeline stages.

In some embodiments, the tuning controller 150 may implement a priority-based scheduling system that categorizes resource adjustments according to their implementation latency and performance impact. High-priority adjustments with minimal latency, such as cache allocation changes, may be applied immediately upon phase detection. Medium-priority adjustments requiring moderate setup time, such as prefetcher reconfiguration, may be scheduled for application during natural execution boundaries such as function calls or loop iterations. Low-priority adjustments with significant latency, such as voltage and frequency scaling, may be applied only when phase predictions indicate sufficient duration to amortize the transition overhead.

In embodiments, the resource adjustment engine 158 may coordinate timing across multiple tunable resource categories 170 to prevent conflicting configuration changes from occurring simultaneously. A dependency matrix may define ordering constraints between different types of adjustments, ensuring that power control resource 172 modifications are completed before memory and cache resource 174 changes are initiated. The configuration manager 156 may implement a rollback mechanism that maintains previous configuration states in a configuration history buffer, allowing rapid restoration of prior settings if performance monitoring indicates that a configuration change has degraded system performance.

The phase-aware selector 152 may implement a confidence-weighted decision mechanism that considers both the certainty of phase detection and the predicted duration of the upcoming phase when selecting tuning strategies. Phase transitions with confidence values below a predetermined threshold may trigger conservative tuning approaches that apply only low-risk optimizations. Phase predictions with high confidence and long predicted duration may enable aggressive tuning strategies that apply comprehensive resource reconfigurations across multiple subsystems. The prediction-utility evaluator 154 may maintain a performance history database that tracks the effectiveness of different tuning strategies for various phase combinations, enabling continuous refinement of the selection criteria.

The timing coordination between phase detection and resource tuning may be achieved through a multi-stage pipeline that overlaps detection latency with configuration preparation. While the phase inference engine 130 analyzes current behavioral indicators 108 to determine the present phase-of-execution 132, the tuning controller 150 may simultaneously prepare configuration parameters for the most likely subsequent phases based on historical transition patterns. This predictive preparation may reduce the effective tuning latency by pre-computing configuration settings before they are needed, allowing near-instantaneous application when phase transitions are confirmed.

As used herein, code 102 represents any software, firmware, or instruction sequence executed by the processing unit 110. In some embodiments, code 102 may include application software, kernel-level code, library functions, or firmware routines. The execution stream 104 refers to the dynamic flow of code on the processing unit 110, observed as processor-level execution events generated at the microarchitectural level, such as instruction retirements, cache accesses, branch predictions, or memory requests. Order and timing sequences of processor-level events resulting from the flow can be significant. In some embodiments, these events are collected as a continuous trace, while in other embodiments they may be sampled to form a representative sequence.

The processing unit 110 may include one or more processor elements, such as a central processing unit (CPU), graphics processing unit (GPU), microcontroller, or specialized computing element (e.g., a multiplier-accumulator (MAC) unit with memory). In some embodiments, the execution stream is captured as discrete events, rather than as aggregated samples, to preserve timing fidelity.

The execution events 106 can include processor-level events detectable at the microarchitectural level of the processing unit 110. Such events may be generated, for example, by a performance monitoring unit (PMU) or other functional components of the processor microarchitecture, including branch predictors, caches, execution pipelines, prefetchers, memory controllers, and translation lookaside buffers (TLBs). The events can capture both positive outcomes (e.g., an instruction retired, a store completed, a cache hit) and negative outcomes (e.g., branch misprediction, cache miss, TLB miss, pipeline stall). In some embodiments, the events 106 may further include timing information or counts, such as cycles elapsed between events or event frequency, which can be used to characterize execution behavior. Collectively, these processor-level events 106 form the raw behavioral signal from which indicators 108 are derived.

The behavioral sensor 120 converts the raw execution events 106 into behavior indicators 108, which may encode both the occurrence of local events and their relative timing. A sequence of such indicators provides higher-level information that the phase inference engine 130 can use for signature matching. In some embodiments, the behavior indicators 108 can be considered ‘consumable events’ as described in U.S. Pat. No. 12,147,326, titled Behavioral Sensor for Creating Consumable Events. That disclosure illustrates one particular embodiment of a behavioral sensor, in which raw processor-level events are transformed into standardized, consumable indicators suitable for downstream analysis. The present behavioral sensor 120 encompasses such embodiments, as well as other mechanisms that derive structured, higher-level indicators from the microarchitectural event stream.

Behavioral indicators 108 are derived signals that abstract raw execution events 106 into higher-level representations of processing unit behavior. For example, an individual indicator may encode the occurrence of a cache miss, a branch misprediction, or a retired instruction, as well as the relative timing between such events. A sequence of behavioral indicators 108 thus captures meaningful execution patterns at the microarchitectural level, providing a compact and consumable representation of the workload's behavior for further analysis.

Phase inference engine 130, which can also be referred to as a pattern detector, consumes the behavioral indicators 108 and identifies phases-of-execution based on these inputs. In some embodiments, the phase inference engine 130 includes a signature engine 131 that constructs observed behavior signatures from the incoming behavioral indicators 108 and pattern-matches them against a catalog of stored profiles 140 representing known execution phases. A behavior signature is a structured representation of an execution phase, defined by a specific sequence or arrangement of behavioral indicators 108. In practice, a behavior signature need not correspond to a complete sequence of events; rather, it may capture characteristic patterns that provide a statistical likelihood of correspondence to a given phase-of-execution. Each such signature reflects the characteristic microarchitectural activity of a phase-of-execution and can be stored in the profile storage medium for later comparison against observed sequences.

Based on this comparison, the phase inference engine 130 outputs at least one phase-of-execution 132, optionally accompanied by a confidence value. The confidence value may increase as additional matching signatures are observed, and may also be refined using contextual information such as the identity of preceding phases (since certain phases are more likely to follow others). In this way, probabilistic modeling can reinforce or refine the inference over time, improving the likelihood of correct detection. In some embodiments, behavior signatures are established or refined using machine learning techniques, and the inference engine may further employ fuzzy logic or state-machine approaches. The inference engine 130 may be realized in hardware (e.g., logic gates, ASIC) or software executed by a processor (either the same processing unit 110 or a different one). In certain embodiments, the inference engine 130 operates in near real time, enabling optimizations or tuning actions to be performed before a subsequent phase transition occurs. As used herein, the confidence value is a measure of how certain the inference engine is that a detected behavior signature corresponds to a particular phase-of-execution.

In some embodiments, the phase profiles 140 may be refined using iterative or feedback-based learning mechanisms. For example, discrepancies between expected behavioral patterns and those observed during operation may trigger refinement of the corresponding profile or adjustment of its confidence-weighting parameters. In certain implementations, generative or reconstruction-based models may be used to detect deviations or to update the characteristic signatures associated with a phase. This iterative feedback process allows the system to maintain accurate and robust phase representations even as workloads evolve or as code paths change over time.

As used herein, a phase-of-execution 132 refers to a relatively high-order stage of program behavior that persists over a region of execution and is distinguishable by characteristic patterns of processor-level execution events. For example, phases 132 may correspond to algorithmic regions (e.g., compression vs. coding), functional modes (e.g., initialization, steady-state operation, cleanup), or other segments of execution that exhibit repeatable microarchitectural behavior. Each phase-of-execution 132 typically engages processor resources in a distinct way—such as exercising caches, branch predictors, or memory pipelines differently from other phases—and can therefore be selectively optimized or tuned. By identifying these phases 132 dynamically, the processing unit 110 can apply targeted optimizations that would not be possible under a non-differentiated workload view, where execution is treated as homogeneous and resource usage patterns are obscured.

FIG. 1C illustrates a representational schematic of a behavioral sensor 120 for generating output including behavioral indicators 108. In this embodiment, the behavioral sensor 120 includes a feature extractor 122 and a classifier 124. The feature extractor 122 is coupled to the processing unit 110 (or another device) to receive a stream 104 of processor-level execution events 106 generated during execution of code 102. The feature extractor 122 identifies salient features of individual events in the stream and associates them with timing information. In some embodiments, a buffer (not shown) is used to capture the event stream prior to feature extraction, while in others the feature extractor 122 is robust enough to directly process events arriving from a processor trace or PMU interface. The feature extractor 122 operates to identify salient characteristics from the event stream, while the classifier 124 assigns identified features to categories representing different behavioral indicators 108.

The feature extractor 122 may be implemented as, for example, a programmable binary state machine, a binary pattern matching engine, a bitstream pattern matcher, a path signature extractor, digital filter, statistical calculator, or other suitable circuitry (including more complex circuitry with or without acceleration). A programmable binary state machine examines events bit by bit, traversing defined states to identify one or more features. A bitstream pattern matcher compares larger fields of an event record (or even the entirety of the record) against predefined patterns. A path signature extractor applies high-dimensional analysis to a sequence of events to derive a unique signature of a path or behavior segment.

As noted, the feature extractor 122 associates each event with timing information. The extracted features may correspond to events of interest such as PMU-monitored outcomes (e.g., branch mispredict, load retired, store retired, branch retired, cache miss). Timing may be measured using a counter within the behavioral sensor 120 or externally by the processing unit 110. The time can be absolute (e.g., wall-clock values such as second, minute, hour, date) or relative (e.g., cycle differences between consecutive events). In one embodiment, relative time is compressed using delta values, optionally with a ceiling value (e.g., 1,000 cycles) enforced by a saturating counter to avoid unbounded representations.

The classifier 124 receives the features identified by the feature extractor 122 and assigns them to one or more predefined categories that correspond to behavioral indicators 108. Classification may include assignment of a confidence measure, rather than binary membership, quantizing the degree of fit (e.g., on a scale of 0-255). The resulting classified events, together with their associated timing, form a temporal series of behavioral indicators 108 that can be consumed by the phase inference engine 130. In some embodiments, the classifier 124 outputs labeled vectors representing values for a subset of categories. Suitable classifier types include nearest-neighbor or approximate-nearest-neighbor classifiers, decision trees, support vector machines, gradient-boosted models (e.g., XG-Boost), or other machine learning techniques. In other embodiments, classifier 124 may employ behavioral locality-sensitive hashing (bLSH) for approximate similarity matching.

In certain embodiments, the labels output by the classifier 124 may be arbitrary in the sense that they are chosen for convenience or design preference rather than inherent necessity. For example, labels may have semantic meaning to a program (e.g., unique identifiers for hashes of basic blocks), may be hand-crafted for known behaviors, or may be learned automatically in an unsupervised or semi-supervised manner. Generally, the phase inference engine may operate regardless of whether it was trained in supervised, unsupervised, or semi-supervised modes, enabling adaptive labeling and inference across varying availability of labeled data.

While classifier labels can be used directly for training phase inference models, alternatives are contemplated. For instance, intermediate embeddings may be produced that project dynamic features into a space that preserves similarity. Such embeddings can accelerate training convergence for complex phase detection models and facilitates knowledge transfer across machine learning tasks.

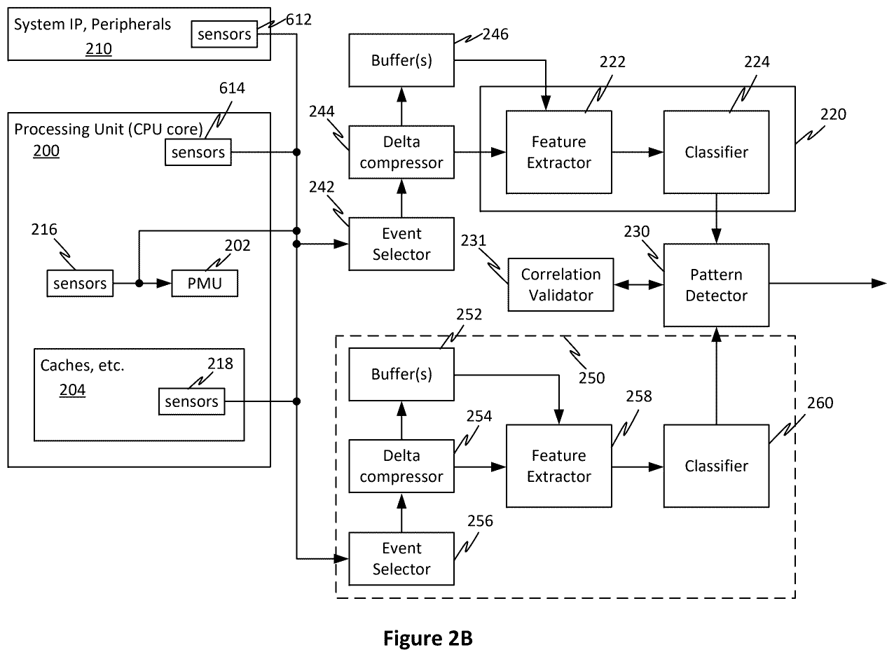

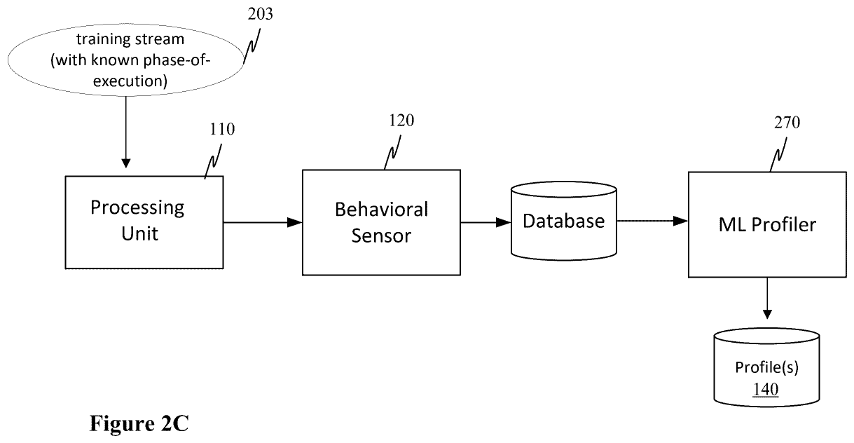

Although FIG. 1C depicts a behavioral sensor 120 with only a feature extractor 122 and classifier 124, alternative implementations may include additional circuitry or subsystems, such as those described in connection with FIGS. 2A and 2B. In some cases, intermediate values from the feature extractor 122 may be exported or made observable, enabling hybrid or multi-stage analysis pipelines.

In further embodiments, waypoints and hints can be employed to augment operation of the feature extractor 122 and classifier 124. Waypoints represent specific milestones or markers injected into a program's execution path, while hints comprise contextual information or annotations (such as compiler-inserted signals) that provide additional guidance. These can assist the classifier in recognizing intent or higher-level program structure. For example, a compiler could inject dummy instructions each time a data stream requires sorting, providing a waypoint detectable by the behavioral sensor 120. In some embodiments, hints may be detected by auxiliary sensors such as sensors 212, 214, 216, or 218 shown in FIG. 2A.

FIG. 2A illustrates a specific implementation of a system with a behavioral sensor used to determine phase-of-execution from processing unit events. Referring to FIG. 2A, a computing system can include a processing unit 200, such as a CPU core, system interfaces and peripherals 210. The processing unit 200 can include a performance monitoring unit (PMU) 202 and memory 204. The processing unit 200 can execute commands/instructions stored in the memory 204. As commands/instructions are performed, certain activities, operations, and behaviors at the processing unit 200 and the system interfaces and peripherals 210 may be considered events.

A number of sensors can be distributed throughout the computing system to detect various events and states. For example, one or more sensors 212 can be located at the system interfaces and peripherals 210, one or more sensors 214 can be located at the processing unit 200, one or more sensors 216 can be for monitoring by the PMU 202, and one or more sensors 218 can be located associated with memory 204 (e.g., caches and memory management, etc.). In the illustrated scenario a behavioral sensor 220 is included to create behavioral indicators from the events (e.g., processing unit events) detected by the various sensors 212, 214, 216, 218 for a pattern detector 230 (e.g., phase inference engine 130) used for determining phase-of-execution.

Behavioral sensor 220 includes feature extractor 222 and classifier 224, which can be configured as described with respect to the behavioral sensor 120 of FIG. 1B. Preprocessing circuitry can be included (and considered part of behavioral sensor 220 or part of the coupling circuitry to the processing unit 200).

FIG. 2B illustrates a specific implementation of the preprocessing circuitry present in some embodiments of the system of FIG. 2A. The preprocessing circuitry can include an event selector 242, a cycle delta compressor 244, and one or more buffers 246. Of course, certain embodiments may omit one or more of these circuit elements and certain embodiments may include additional circuit elements in addition to or in place of the event selector 242, cycle delta compressor 244, and one or more buffers 246.

The event selector 242 can receive input of events of the event stream from one or more sources (e.g., from any of sensors 212, 214, 216, 218) and selects events based on one or more criteria. The criteria can include type of processor commands, number of cycles, or other predefined constraints. The event selector 242 is used to constrain the complexity of the feature extractor 222 so that the feature extractor 222 works from a subset of signals. That is, the event selector 242 provides a reduced event stream to the feature extractor 222. The event selector 242 can be embodied as a multiplexor, wherein a select line of the multiplexor can determine whether to allow an event on a bus line of the multiplexor to pass. The select pin can be controlled externally, for example by a processor that only allow certain events to pass. In other instances, the select pin can be coupled to a particular sensor or PMU to only allow events from particular sources. In other cases, a particular bit of the event can be fed to the select pin (e.g., an event comprising of seven bits can include six bits of data about the event and one bit that is used as a flag). In another implementation, the event selector can be a bit-mask that merges multiple sources of events into a single bitstream (e.g., combining loads and stores into a single “load or store” event).

The cycle delta compressor 244 can be used when relative time is used as the time value in the time series to determine the number of cycles between valid events. Because CPUs do not generate events on every cycle, the delta compressor 244 can be used to compress 0-space with run-length-encoding. That is, the delta compressor 244 can count the number of empty samples and save this delta as the cycle delta from the previous non-empty sample. In this manner, the cycle delta compressor 244 generates a count of a number of empty cycles between events of the event stream. The delta compressor 244 can include a counter (e.g., in the form of a number of flip-flops connected in cascade). The counter can be regularly incremented, for example by a clock circuit. When a valid event is received, the counter can be read and the value (that is the differential in time between two valid events) can be stored as the time and forwarded with the event. The counter can then be reset. In some cases, the counter used in the delta compressor 244 can be a saturating counter, wherein a ceiling value is included, beyond which the counter cannot increment. For example, the ceiling value can be 1,000 cycles-if an event were to occur more than 1,000 cycles after an immediately previous valid event, then a value of 1,000 cycles can be assigned as the time despite the actual number of cycles being greater than 1,000.

The one or more buffers 246 can serve to slow down receipt of events. In some cases, events are produced at a greater rate than can be processed by the feature extractor 222 or classifier 224. To prevent these events from being discarded or conflicting with events currently being processed, a buffer 246 can be used to store events until the feature extractor 222 or classifier 224 are ready. The buffer 246 can be, for example, a digital buffer, storage resource, static random-access memory (SRAM), or flip-flop circuit. In some cases, the buffer 246 automatically pushes received events to the feature extractor 222, and, in other cases, the buffer 246 receives a signal from the feature extractor 222 or the classifier 224 that indicates that the previous event has been processed by one or both of the feature extractor 222 and the classifier 224. In some cases, there may be an additional buffer between the feature extractor 222 and the classifier 224.

Additional event collection systems 250 can be included as part of the system (with consumable events provided to the pattern detector 230), each including their own buffers 252, cycle delta compressor 254, event selector 256, feature extractor 258, and classifier 260.

Pattern detector 230 (e.g., phase inference engine 130) can be considered a security system such as described in FIG. 1A. In some cases, pattern detector 230 can be a higher order machine learning or statistical system implemented, for example, with neural networks, deep learning techniques. Pattern detector 230 can perform high-level decisions on mitigation and reporting.

FIG. 2C shows a schematic diagram where a machine-learning (ML) profiler 270 establishes behavioral signatures for the profile storage medium. Generally, a training stream 203 having a known phase-of-execution is conveyed to the processing unit 110, and the behavioral sensor 120 produces sequences of behavioral indicators from processing unit events. These sequences can be stored for offline or online training. In some embodiments, training data is generated by replaying known executions through the behavioral classifiers or by sampling real data from the field, optionally sanitized before use. The ML profiler 270 discovers patterns in the sequences and creates signatures indexed to known phases-of-execution, improving signature distinctiveness as more diverse training streams 203 are incorporated.

In some embodiments, the ML profiler 270 (or a separately implemented one) may also train an inference engine to select (e.g., phase-aware selector 152) phase specific adjustments 162 to optimally tune resources 160 for a predicted stream. In some embodiments a confidence value or level in the phase-of-execution determination or prediction can be considered by the phase-aware selector. That is, because an “improper” adjustment (162) can degrade performance, conservative adjustments accounting for potential “error” in the inference can be applied when a confidence level in a phase-of-execution 132 is relatively low, while a more aggressive adjustment can be applied when the confidence level in a phase-of-execution 132 determination/prediction is relatively high.

The ML profiler 270 may employ supervised, unsupervised, or semi-supervised techniques, including clustering methods, autoencoder-based representations, or other statistical or neural models to map behavioral indicators into an internal phase-of-execution state space. For example, graph-based models or graph autoencoders may learn typical transition structures between internal states, with persistent deviations or high reconstruction error indicating anomalous or unexpected execution behavior. Generative or feedback-based training loops, such as those used in generative adversarial networks (GANs) or related semi-supervised frameworks, may be used to improve model robustness, and approximate nearest-neighbor search can assist in clustering and labeling large behavioral datasets. These mechanisms collectively enable efficient learning of phase signatures and transition patterns from unlabeled or partially labeled training data.

Because behavioral indicators form time-ordered sequences, the ML profiler 270 may also employ sequence models to interpret or classify behaviors over windows of execution. In different embodiments, transitions may be modeled using graph structures and graph neural networks, convolutional neural networks applied over temporal windows, attention-based models such as transformers, or recurrent neural networks (RNNs) suited for time-series analysis. In some cases, a larger or more expressive model is trained first and then distilled to a smaller model using teacher-student techniques to reduce deployment cost. These modeling options are illustrative rather than limiting; any suitable learning architecture that can map behavioral sequences to internal phase-of-execution representations or transition structures may be used.

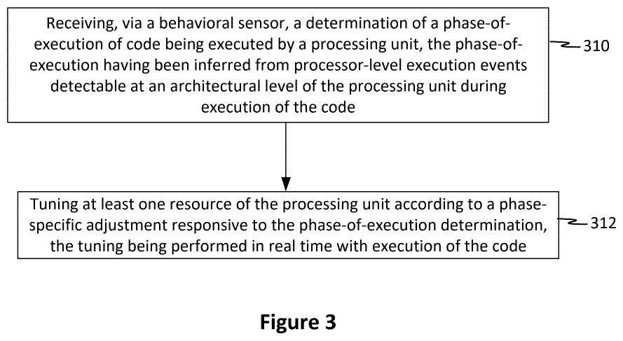

FIG. 3 illustrates a method for phase-aware resource tuning in a processing unit. At step 310, a behavioral sensor receives or determines a phase-of-execution of code being executed by a processing unit. The phase-of-execution is inferred from processor-level execution events that are detectable at the architectural level during runtime. At step 312, one or more resources of the processing unit are tuned in accordance with a phase-specific adjustment determined in response to the phase-of-execution determination. The tuning may be performed in real time, such that adjustments occur as execution progresses and without substantive interruption to program flow.

In some embodiments, the tuning includes adjusting, prior to a predicted transition between phases of execution, at least one of a clock frequency or an operating voltage of the processing unit to optimize power efficiency or throughput for an upcoming phase of execution. In certain embodiments, the tuning further includes power-gating at least one hardware resource predicted to remain unused during an upcoming span of time based on the determined phase-of-execution, thereby reducing power consumption and temperature of the processing unit during at least an initial portion of the upcoming span of time. In some embodiments, the tuning further includes adjusting a cache configuration of the processing unit based on the determined phase-of-execution to optimize memory-access performance for a predicted subsequent phase. In certain embodiments, the tuning includes adjusting a prefetching policy of the processing unit based on the determined phase-of-execution, including enabling, disabling, or modifying one or more hardware prefetchers prior to a predicted transition into a subsequent phase of execution to improve data availability and reduce memory-access latency during the subsequent phase. In some embodiments, the tuning includes modifying one or more branch prediction parameters of the processing unit in anticipation of a predicted subsequent phase of execution to reduce misprediction overhead and enhance control-flow efficiency. In certain embodiments, the tuning includes selectively enabling or restricting speculative-execution mechanisms of the processing unit in anticipation of a predicted subsequent phase of execution to minimize mis-speculation cost.

In some embodiments, the behavioral sensor communicates the inferred phase-of-execution to a controller that selects from among a plurality of resource adjustment strategies. The controller may apply or schedule changes to operational parameters, including, but not limited to, voltage, frequency, cache allocation, or execution mode, thereby optimizing processing unit behavior for the detected phase. This method enables dynamic, phase-driven adaptation of hardware resources to improve performance, efficiency, or reliability during program execution.

In certain embodiments, the method includes determining a probability of the subsequent phase-of-execution being correctly predicted; estimating a performance improvement achieved by applying the tuning should the prediction of the subsequent phase-of-execution be accurate; estimating a performance degradation resulting from applying the tuning should the predicted phase-of-execution be inaccurate; and applying the tuning only when an expected overall performance improvement is positive, based on the probability of the predicted subsequent phase-of-execution being correct, the estimated performance improvement if correct, and the estimated performance degradation if incorrect.

In some embodiments, the method includes establishing, for the processing unit, a plurality of configurations each defining parameter values optimizing performance or power efficiency for a corresponding phase-of-execution; selecting, responsive to the determination of the phase-of-execution, a configuration associated with a predicted subsequent phase-of-execution; and applying the selected configuration prior to commencement of the predicted subsequent phase-of-execution.

FIG. 4 provides a sample use case for predicting phase-of-execution and for responsively tuning a processing unit to improve performance. In the use case, the phase inference engine is able to determine that a program (e.g., code) is running some variant of Lempel-Ziv77 (LZ77), which is a first part of ZIP's DEFLATE methodology and will likely run HUFFMAN coding in the next phase-of-execution. The ability to chain together different behaviors at different resolutions and to then reason based on these behaviors provides a heretofore untapped manner to improve processing efficiency/performance.

In step 410 of the example of FIG. 4, the processing unit executes code. In step 412, a sequence of behavior indicators is generated. In step 414, the phase inference engine (e.g., pattern detector) and specifically the signature engine 131 determines a signature of the sequence of indicators (108) is consistent with the LZ77 algorithm. The tunable controller 150 is aware that LZ77 (in an execution state after the determination is made) has an associated optimization/tuning for the remaining processing (significant enough to offset overhead accounting for uncertainty of the determination). In step 416, a set of one or more phase specific adjustments are performed, where the processing unit/related resources (tunable resources 160) are tuned for LZ77 processing. A level of latency is involved in inferring a current phase from behavior of code running in that phase, which may minimize a value in a performance optimization. However, some phases-of-execution are able to predict future phases of execution, which avoids latency type issues.

In step 418, the phase inference engine and/or the tuning controller is trained to know that the LZ77 algorithm is a first part (phase) of a DEFLATE methodology that is paired with a second part (phase) of HUFFMAN coding. In step 420, the next phase-of-execution can be predicted as a HUFFMAN coding phase. This prediction occurs prior to the HUFFMAN phase-of-execution executing. In step 422, immediately prior (approximately) to a handling of an execution stream for HUFFMAN coding, the processing unit and related resources can be tuned for the HUFFMAN coding, which was identified as the next phase-of-execution.

In the example of FIG. 4, the phases-of-execution as labeled/utilized equate to a LZ77 phase and a HUFFMAN coding phase, which are relatively high order behavior-based phases. Different phase-of-execution categories are contemplated and labels associated with phases-of-execution can be directly associated with a part of a program (e.g., code), can be learned in an unsupervised fashion, or can be a combination of the two taking a semi-supervised form.

From the example, our phase-of-execution detection consumes behavioral indicators 108 and determines approximate phase similarity and correlates this with inter-phase transitions via graph structures. Roughly speaking in certain embodiments, output can be a vector representing a behavioral measurement in compressed form along with a multilabel list of relevant identified behaviors and their corresponding scores. A sequence of behavior indicators is consumed to identifying a behavioral signature, a predicted future phase-of-execution (e.g., HUFFMAN coding from LZ77 signature matching), or both to identify higher order behaviors present in the handling of an execution stream. This can be considered examining a behavioral phase over some meta-window. Dynamic behavior measured and utilized during this process, which is contrasted with an approach of correlating phase-of-execution to structure of code that is not dynamically measured.

In certain embodiments, portions of the behavioral sensor, signature construction, and inference logic execute in firmware or hardware positioned proximate to microarchitectural telemetry sources (e.g., a PMU, trace fabric, or other on-die observability interfaces) to meet latency targets, while catalog management and model updates may execute in software. In other embodiments, these functions may reside in any combination of on-core microcode, on-die accelerators, near-die controllers, system firmware, a co-processor, or host software processes. Confidence scores and thresholds govern when to emit phase determinations or apply tuning actions, and hierarchical signatures permit identification of both phases and sub-phases. This arrangement preserves event-level fidelity and enables low-latency, real-time decisions without requiring prior knowledge of the application's codebase, and is not limited to use of a PMU or any particular deployment topology.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts that would be recognized by one skilled in the art are intended to be within the scope of the claims.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

What is claimed is:

1. A method of tuning a processing unit executing code, comprising:
receiving a determination of a phase-of-execution of code being executed by a processing unit, the phase-of-execution having been inferred from processor-level execution events detectable at an architectural level of the processing unit during execution of code; and
tuning at least one resource of the processing unit according to a phase-specific adjustment responsive to the phase-of-execution determination, the tuning being performed in real time with execution of the code.

2. The method of tuning of claim 1, wherein the receiving of the determination of the phase-of-execution occurs prior to a predicted, subsequent phase-of-execution of the code executing, wherein the tuning prepares for the subsequent phase-of-execution and is performed prior to the subsequent phase-of-execution initiating as the code is being executed.

3. The method of tuning of claim 2, further comprising:
determining a probability of the subsequent phase-of-execution being correctly predicted;
estimating a performance improvement achieved by applying the tuning should the prediction of the subsequent phase-of-execution be accurate;
estimating a performance degradation resulting from applying the tuning should the predicted phase-of-execution be inaccurate; and
applying the tuning only when an expected overall performance improvement is positive, based on the probability of the predicted subsequent phase-of-execution being correct, the estimated performance improvement if correct, and the estimated performance degradation if incorrect.

4. The method of tuning of claim 1, further comprising:
establishing, for the processing unit, a plurality of configurations each defining parameter values optimizing performance or power efficiency for a corresponding phase-of-execution;
selecting, responsive to the determination of the phase-of-execution, a configuration associated with a predicted subsequent phase-of-execution; and
applying the selected configuration prior to commencement of the predicted subsequent phase-of-execution.

5. The method of tuning of claim 1, wherein the at least one resource comprises a hardware resource associated with at least one of: power gating, dynamic voltage and frequency scaling, cache configuration, prefetch control, branch prediction, and speculative execution.

6. The method of claim 1, wherein the tuning further comprises:
power-gating at least one hardware resource predicted to remain unused during an upcoming span of time based on the determined phase-of-execution, thereby reducing power consumption and temperature of the processing unit during at least an initial portion of the upcoming span of time.

7. The method of claim 1, wherein the tuning further comprises:
adjusting, prior to a predicted transition between phases of execution, at least one of a clock frequency or an operating voltage of the processing unit to optimize power efficiency or throughput for an upcoming phase of execution.

8. The method of claim 1, wherein the tuning further comprises:
adjusting a cache configuration of the processing unit based on the determined phase-of-execution to optimize memory-access performance for a predicted subsequent phase.

9. The method of claim 1, wherein the tuning further comprises:
adjusting a prefetching policy of the processing unit based on the determined phase-of-execution, including enabling, disabling, or modifying one or more hardware prefetchers prior to a predicted transition into a subsequent phase of execution to improve data availability and reduce memory-access latency during the subsequent phase.

10. The method of claim 1, wherein the tuning further comprises:
modifying one or more branch prediction parameters of the processing unit in anticipation of a predicted subsequent phase of execution to reduce misprediction overhead and enhance control-flow efficiency.

11. The method of claim 1, wherein the tuning further comprises:
selectively enabling or restricting speculative-execution mechanisms of the processing unit in anticipation of a predicted subsequent phase of execution to minimize mis-speculation cost.

12. The method of tuning of claim 1, wherein the phase-of-execution comprises a workload pattern state inferred from processor-level activity observed during execution of the code, the workload pattern state being determined dynamically based on microarchitectural event patterns of the processing unit and not from any static or compile time knowledge of a respective code structure.

13. A tuning system configured to interface with a processing unit executing code, the tuning system comprising:
a monitoring interface configured to receive, from the processing unit, processor-level execution events detectable at an architectural level during execution of the code;
a phase-inference engine configured to infer a phase-of-execution of the code based on the processor-level execution events; and
a tuning controller configured to tune at least one resource parameter of the processing unit according to a phase-specific adjustment responsive to the inferred phase-of-execution, wherein the tuning controller performs the tuning in time with execution of the code.

14. The tuning system of claim 13, wherein the phase-of-execution is inferred prior to a predicted, subsequent phase-of-execution of the code executing, wherein the tuning controller prepares for the subsequent phase-of-execution and is performed prior to the subsequent phase-of-execution initiating as the code is being executed.

15. The tuning system of claim 13, wherein the tuning controller is further configured to:
determine a probability of a subsequent phase-of-execution being correctly predicted;
estimate a performance improvement achieved by applying tuning should the prediction of the subsequent phase-of-execution be accurate;
estimate a performance degradation resulting from applying tuning should the subsequent phase-of-execution prediction be inaccurate; and
applying tuning only when an expected overall performance improvement is positive, based on the probability of the subsequent phase-of-execution prediction being correct, the estimated performance improvement if correct, and the estimated performance degradation if incorrect.

16. The tuning system of claim 13, wherein the phase-inference engine is further configured to:
establish, for the processing unit, a plurality of configurations each defining parameter values optimizing performance or power efficiency for a corresponding phase-of-execution; and
select, responsive to the determination of the phase-of-execution, a configuration associated with a predicted subsequent phase-of-execution, wherein the tuning controller is configured to:
apply the selected configuration prior to commencement of the predicted subsequent phase-of-execution.

17. The tuning system of claim 13, wherein the at least one resource parameter comprises a parameter for hardware resource associated with at least one of: power gating, dynamic voltage and frequency scaling, cache configuration, prefetch control branch prediction, and speculative execution.

18. A non-transitory computer-readable medium storing instructions which, when executed by one or more processors of a processing unit, cause the processing unit to perform a method comprising:
receiving a determination of a phase-of-execution of code being executed by the processing unit, the phase-of-execution having been inferred from processor-level execution events detectable at an architectural level of the processing unit during execution of the code; and
tuning at least one resource parameter of the processing unit according to a phase-specific adjustment responsive to the determined phase-of-execution, the tuning being performed in real time with execution of the code.

19. The non-transitory computer-readable medium of claim 18, wherein the receiving of the determination of the phase-of-execution occurs prior to a predicted, subsequent phase-of-execution of the code executing, wherein the tuning prepares for the subsequent phase-of-execution and is performed prior to the subsequent phase-of-execution initiating as the code is being executed.
